(19) United States
(12) Patent Application Publication
(10) Pub. No.: US 2010/0236865 A1
(43) Pub. Date: Sep. 23, 2010

(54) Ladder Access Control Kit And Ladder Assembly Including Access Control Apparatus

(76) Inventors: Daniel J. Crowton, Goodells, MI (US); James G. Drobniewski, Macomb, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/406,991

(22) Filed: Mar. 19, 2009

(51) Int. Cl. E06C 7/00

(52) U.S. Cl. 182/129

(57) ABSTRACT

A ladder access control kit and a ladder assembly including access control apparatus are provided. The kit includes a planar barrier and a first member having a first support structure to movably support the barrier and a first attachment mechanism to secure the first support structure at a first side of the ladder. The barrier is movable within a plane of the barrier between an access position to allow access to the ladder and a blocking position to prevent access to the ladder. The kit also includes a second member including a second support structure and a second attachment mechanism to secure the second support structure at a second side of the ladder spaced apart from the first side of the ladder. The kit further includes a locking device to fasten the barrier to the second support structure in a locked condition of the device and in the blocking position of the barrier to prevent unauthorized access to the ladder.

### BACKGROUND OF THE INVENTION

1. Technical Field

This invention relates to ladder access control kits and ladder assemblies including access control apparatus.

2. Background Art

It is often desirable to prevent unauthorized users from climbing on a ladder which extends from one location to a desired but unauthorized location. For example, a ladder may extend from the ground to a tree-mounted stand for hunting. Another example is a ladder which extends from the ground to the upper platform of an above-ground swimming pool. Other ladders are secured to a man-made structure to allow an authorized user access to a boat in a marina or to perform maintenance or otherwise access a vertically displaced portion of the man-made structure.

The following U.S. patent documents describe various ladder anti-climbing or blocking devices and assemblies: 2002/0092704; U.S. Pat. Nos. 5,832,755; 5,441,126; 5,343,977; 4,579,197; 4,450,937; 4,181,195; 4,126,206; 3,968,857 and 3,225,863.

At least one problem associated with many of the prior art ladder anti-climbing or blocking devices and assemblies is that such devices and assemblies are ineffective in providing a compact, simple and inexpensive solution to the problem of blocking unauthorized climbing on ladders.

### SUMMARY OF THE INVENTION

An object of the present invention is to provide a ladder access control kit and ladder assembly including access control apparatus which are relatively compact, simple and inexpensive yet effectively block unauthorized users from climbing on ladders.

In carrying out the object and other objects of the present invention, a ladder access control kit is provided. The kit includes a planar barrier and a first member including a first support structure to movably support the barrier and a first attachment mechanism to secure the first support structure at a first side of the ladder. The barrier is movable within a plane of the barrier between an access position to allow access to the ladder and a blocking position to prevent access to the ladder when the first attachment mechanism secures the first support structure to the first side of the ladder and the first support structure movably supports the barrier. The kit also includes a second member including a second support structure and a second attachment mechanism to secure the second support structure at a second side of the ladder spaced apart from the first side of the ladder. The kit further includes a locking device to fasten the barrier to the second support structure in a locked condition of the device and in the blocking position of the barrier when the first support structure movably supports the barrier and the first and second attachment mechanisms secure their respective support structures to the sides of the ladder to prevent unauthorized access to the ladder.

The barrier may move by rotating about a pivot axis perpendicular to the plane of the barrier. The first support structure may include a pivot to allow the barrier to pivot about the pivot axis.

The barrier may include an aperture formed therein wherein the locking device includes a bolt having extended and retracted positions. The bolt is in its extended position in the aperture in the locked condition to fasten the barrier to the second support structure in the blocking position when the locking device is supported on the second support structure. The aperture may comprise an elongated slot wherein the kit can be utilized with ladders of different widths. The aperture may extend completely through the barrier wherein the second member further includes a shield which covers a distal end of the bolt in the extended position of the bolt.

The locking device may be supported on the second support structure either above or below the barrier when the barrier is in its blocking position to prevent unauthorized users from climbing on the ladder while allowing authorized users to unlock the locking device. The locking device may be a keyed locking device wherein the kit further comprises a key to unlock the locking device.

Further in carrying out the above object and other objects of the present invention, a ladder access control kit is provided. The kit includes a planar barrier including an elongated slot formed completely therethrough wherein the kit can be utilized with ladders of different widths. The kit also includes a first member including a first support structure to movably support the barrier and a first attachment mechanism to removably secure the first support structure to a first side rail of the ladder. The first support structure has a pivot to allow the barrier to pivot about a pivot axis perpendicular to the barrier within a plane of the barrier between an access position to allow access to the ladder and a blocking position to prevent access to the ladder when the first attachment mechanism secures the first support structure to the first side rail of the ladder and the first support structure including the pivot pivotally supports the barrier. The kit further includes a second member including a second support structure, a shield and a second attachment mechanism to removably secure the second support structure and the shield to a second side rail of the ladder. Still further the kit includes a keyed locking device including a bolt having extended and retracted positions. The bolt is in its extended position in the slot and the shield covers a distal end of the bolt in a locked condition of the device to fasten the barrier to the second support structure in the blocking position when the first and second attachment mechanisms secure their respective support structures to the side rails of the ladder, and when the first support structure including the pivot pivotally supports the barrier. The kit further includes a key to unlock the locking device.

Still further in carrying out the above object and other objects of the invention, a ladder assembly including access control apparatus is provided. The assembly includes a ladder and a first member including a first support structure and a first attachment mechanism which secures the first support structure to a first side of the ladder. The assembly also includes a second member including a second support structure and a second attachment mechanism which secures the second support structure to a second side of the ladder spaced apart from the first side of the ladder. The assembly further includes a planar barrier supported by the first support structure to move within a plane of the barrier between an access position to allow access to the ladder and a blocking position to prevent access to the ladder. Still further the assembly includes a locking device which fastens the planar barrier to the second support structure in a locked condition of the device in the blocking position of the barrier to prevent unauthorized access to the ladder.

The locking device may be a keyed or combination locking device.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1a is an environmental view of a first embodiment of an access control kit after being assembled and secured to a ladder to form an assembly including a barrier locked in its blocking position (solid lines) by a locking device located below the barrier to prevent an unauthorized user from climbing up the ladder and having access to a tree stand and also showing an access position of the barrier (phantom lines);

FIG. 1b is a marine environmental view of a different embodiment of the access control kit after being assembled and secured to a ladder to form an assembly with the locking device located above the barrier to prevent an unauthorized user from climbing from an upper level to a lower level down the ladder;

FIG. 1c is yet another environmental view of a third embodiment of a kit similar to the embodiment of FIG. 1 a after being assembled and secured to a ladder in an above-ground, pool application;

FIG. 2a is a bottom perspective view, partially broken away, of one embodiment of a locking device for use with the kit or assembly of FIG. 1a; and

FIG. 2b is a view similar to the view of FIG. 2a but illustrating a second embodiment of the locking device;

FIG. 3 is a side view, partially broken away, illustrating a bolt of the locking device in its extended position within a slot of the barrier thereby locking the barrier in its blocking position;

FIG. 4 is a side view, partially broken away, illustrating a first support structure including a pivot to pivotally support the barrier; and

FIG. 5 is an exploded perspective view of the kit of the first embodiment shown relative to side rails of the ladder.

### DETAILED DESCRIPTION OF THE PREFERRED EMBODIMENT(S)

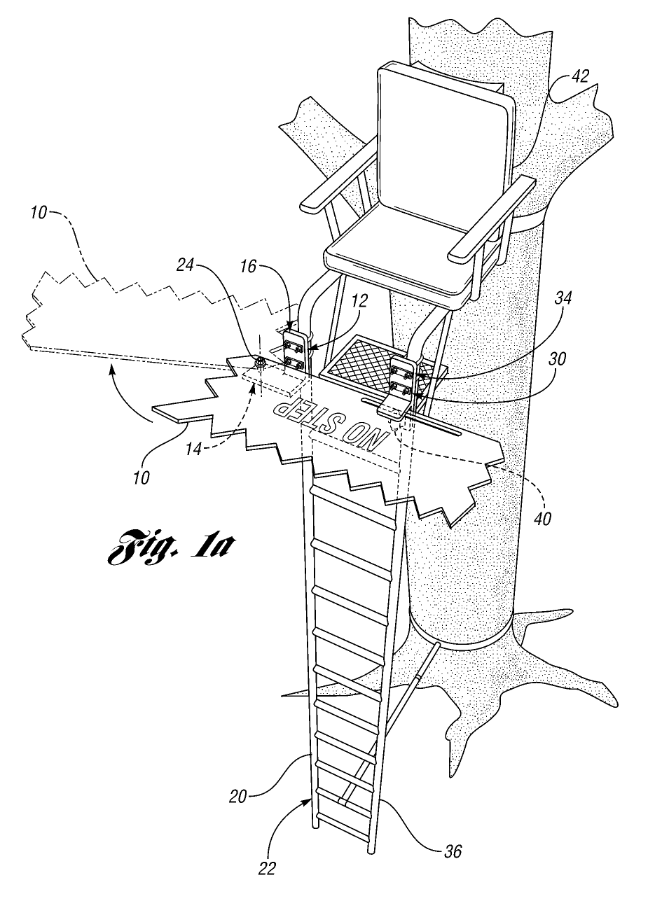

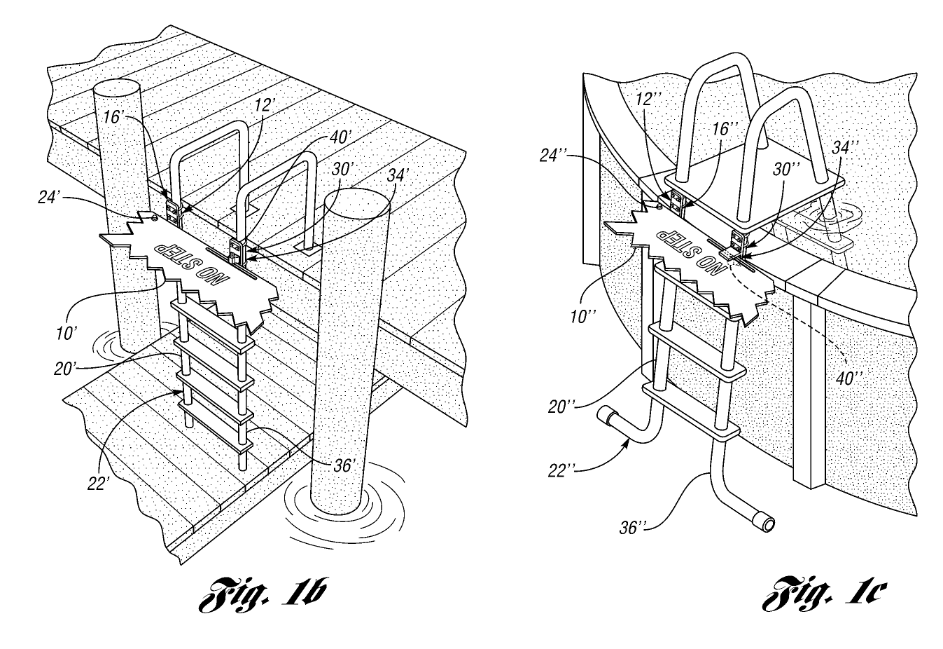

Referring to FIGS. 1a, 1b and 1c, different embodiments of access control kits assembled and secured to side rails of ladders in different applications are shown. A first embodiment is shown in FIGS. 1a, 2a and 3-5. A second embodiment is shown in FIG. 1b with the same reference members for the same or similar parts as in FIG. 1a but with a single prime designation. A third embodiment is shown in FIG. 1c with the same reference number as in FIGS. 1a and 1b for the same or similar parts but with a double prime designation. FIG. 2b shows a second embodiment of a locking device, otherwise the kit is the same as the first embodiment of the kit.

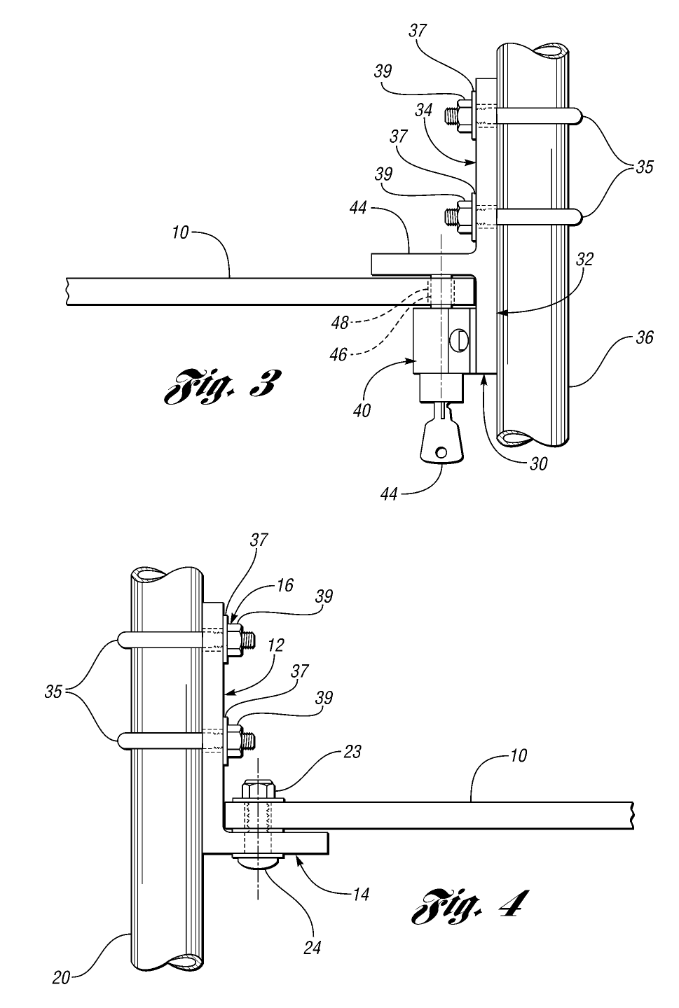

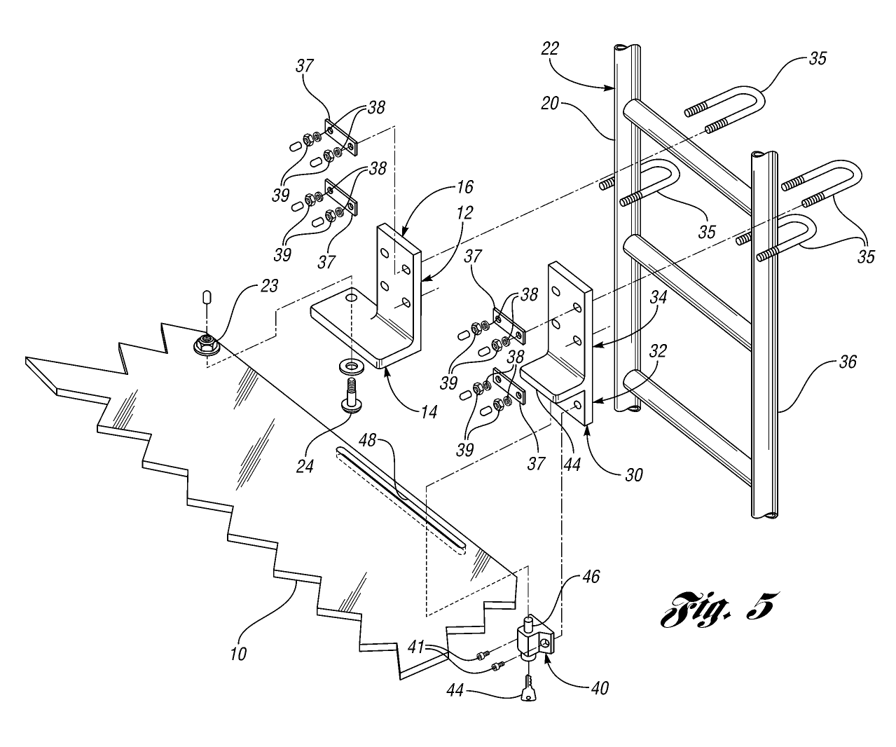

The first embodiment of the ladder access control kit includes a planar barrier 10 and a first member 12 including a first support structure 14 to movably support the barrier 10. The first member 12 also includes a first attachment mechanism 16 to secure the first support structure 14 at a first side or rail 20 of a ladder 22. The barrier 10 is movable within a plane of the barrier 10 between an access position (phantom lines in FIG. 1a) to allow access to the ladder 22 and a tree stand 42 and a blocking position (solid lines in FIG. 1a) to prevent access to the ladder 22 and the tree stand 42 when the first attachment mechanism 16 secures the first support structure 14 to the first side 20 of the ladder 22 and the first support structure 14 including a pivot 24 movably supports the barrier 10 to pivot about an axis generally perpendicular to the plane of the barrier 10. The pivot 24 may take the form of a bolt which extends through the barrier 10 and the structure 14 and is threadably secured to the barrier 10 by a nut 23 located at the top surface of the barrier 10 (FIGS. 4 and 5).

The kit of the first embodiment also includes a second member 30 having a second support structure 32 (FIGS. 2a-5) and a second attachment mechanism 34 to secure the second support structure 32 at a second side or rail 36 of the ladder 22 spaced apart from the first side 20 of the ladder 22.

The kit of the first embodiment also includes a locking device which may be a keyed locking device 40 or a combination locking device 40″′ as shown in FIGS. 2a and 2b, respectively, to fasten the barrier 10 to the second support structure 32 in a locked condition of the device 40 or 40″′ and in the blocking position of the barrier 10. Preferably, the locking device 40 or 40″′ can be unlocked with one hand with the other hand free to perform some other function such as to hold onto the ladder 22. This is possible when the first support structure 14 pivotally supports the barrier 10 and the first and second attachment mechanisms 16 and 34, respectively, secure their respective support structures 14 and 32 to the sides 20 and 36 of the ladder 22 to prevent unauthorized access to the ladder 20.

In other words, the first embodiment of the present invention can be thought of as a lockout kit or apparatus adapted to be attached to a ladder such as the ladder 22 which extends to the tree-mounted stand 42 used for hunting as shown in FIG. 1a. Unless one has a key (i.e., 44 in FIGS. 2a, 3 and 5) or a combination for the locking device 40 or 44″, respectively, the barrier 10 of the kit blocks one from climbing up the ladder 22 thereby preventing unauthorized access to the tree stand 42. The lockout kit or apparatus thereby helps to prevent the destruction, theft or unauthorized use of the stand 42. Obviously, other uses of the lockout kit or system are contemplated wherein the lockout kit or apparatus prevents one from either climbing down or up a ladder 22′ or 22″ as illustrated in FIGS. 1b and 1c, respectively.

As previously mentioned, the barrier has a closed or blocking position (solid lines in FIGS. 1a, 1b and 1c) on the ladder as well as an open position (phantom lines in FIG. 1a). The barrier prevents one from climbing on the ladder, either up or down, in its closed or blocking position while allowing one to climb on (either up or down) the ladder in its open or access position.

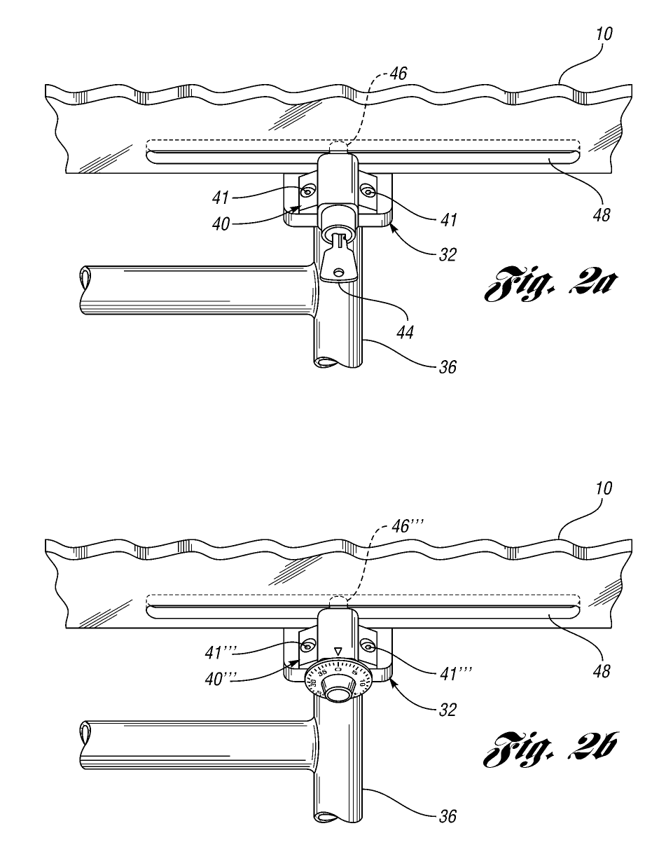

As previously mentioned, the kit or apparatus of the first embodiment includes the first and second members 12 and 34, respectively, having their attachment mechanisms 16 and 34 for attaching their support structures 14 and 32, respectively, to the side pieces or rails 20 and 36 of the ladder 22. In the first embodiment, the attachment mechanisms 16 and 34 of the first and second members 12 and 30, respectively, are removably secured to the side rails 20 and 36 of the ladder 22 by conventional u-bolts 35, nuts 39, plates 37 and washers 38 as best shown in FIGS. 3-5. The first support structure 14 including the pivot 24 pivotally attaches the barrier 10 to the first member 12 so that the barrier 10 can pivotally move between its blocking and access positions. Obviously, other types of attachment mechanisms can be used.

As previously mentioned, the locking device locks or fastens the barrier 10 to the second support structure 32. The locking device is either a keyed or a combination lock 40 or 40″′ as shown in FIGS. 2a and 2b, respectively, and is fixedly secured by screws 41 to a vertically extending portion of the second support structure 32 below the barrier 10 in FIGS. 1a and 1c. A horizontal portion or shield 44 of the second member 34 extends over a distal end of a bolt 46 of the locking device 40 in the blocking position of the barrier 10 in the embodiments of FIGS. 1a and 1c to protect the bolt 46 and thus the locking device 40. The bolt 46 has extended (locked) and retracted (unlocked) positions. A shield 44′ of the second member 34′ extends under and protects the bolt 46′ in the embodiment of FIG. 1b wherein the locking device 40′ is positioned above the barrier 10′ and secured to its support structure (not shown).

The bolt 46 extends through an elongated slot 48 of the barrier 10 in its extended position when the device 40 is locked thereby locking the barrier 10 to the second support structure 32. The bolt 46 moves to its retracted position when the device 40 is unlocked. The device 40 fastens the barrier 10 to the second structure 32 by means of the key 44 (i.e., FIGS. 2a, 3 and 5) or by the combination (i.e., FIG. 2b). The elongated slot 48 is provided in the barrier 10 so that the kit or apparatus may be used for multiple applications and/or different ladder widths.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A ladder access control kit comprising:
a planar barrier;
a first member including a first support structure to movably support the barrier and a first attachment mechanism to secure the first support structure at a first side of the ladder, the barrier being movable within a plane of the barrier between an access position to allow access to the ladder and a blocking position to prevent access to the ladder when the first attachment mechanism secures the first support structure to the first side of the ladder and the first support structure movably supports the barrier;
a second member including a second support structure and a second attachment mechanism to secure the second support structure at a second side of the ladder spaced apart from the first side of the ladder; and
a locking device to fasten the barrier to the second support structure in a locked condition of the device and in the blocking position of the barrier when the first support structure movably supports the barrier and the first and second attachment mechanisms secure their respective support structures to the sides of the ladder to prevent unauthorized access to the ladder.

2. The kit as claimed in claim 1, wherein the barrier moves by rotating about a pivot axis perpendicular to the plane of the barrier.

3. The kit as claimed in claim 2, wherein the first support structure includes a pivot to allow the barrier to pivot about the pivot axis.

4. The kit as claimed in claim 1, wherein the barrier includes an aperture formed therein and wherein the locking device includes a bolt having extended and retracted positions, the bolt being in its extended position in the aperture in the locked condition to fasten the barrier to the second support structure in the blocking position when the locking device is supported on the second support structure.

5. The kit as claimed in claim 4, wherein the aperture comprises an elongated slot and wherein the kit can be utilized with ladders of different widths.

6. The kit as claimed in claim 4, wherein the aperture extends completely through the barrier and wherein the second member further includes a shield which covers a distal end of the bolt in the extended position of the bolt.

7. The kit as claimed in claim 1, wherein the locking device is supported on the second support structure.

8. The kit as claimed in claim 7, wherein the locking device is supported on the second support structure either above or below the barrier when the barrier is in its blocking position to prevent unauthorized users from climbing on the ladder while allowing authorized users to unlock the locking device.

9. The kit as claimed in claim 1, wherein the locking device is a keyed locking device and wherein the kit further comprises a key to unlock the locking device.

10. A ladder access control kit comprising:
a planar barrier including an elongated slot formed completely therethrough wherein the kit can be utilized with ladders of different widths;
a first member including a first support structure to movably support the barrier and a first attachment mechanism to removably secure the first support structure to a first side rail of the ladder, the first support structure having a pivot to allow the barrier to pivot about a pivot axis perpendicular to the barrier within a plane of the barrier between an access position to allow access to the ladder and a blocking position to prevent access to the ladder when the first attachment mechanism secures the first support structure to the first side rail of the ladder and the first support structure including the pivot pivotally supports the barrier;
a second member including a second support structure, a shield and a second attachment mechanism to removably secure the second support structure and the shield to a second side rail of the ladder;
a keyed locking device including a bolt having extended and retracted positions, the bolt being in its extended position in the slot and the shield covering a distal end of the bolt in a locked condition of the device to fasten the barrier to the second support structure in the blocking position when the first and second attachment mechanisms secure their respective support structures to the side rails of the ladder, and when the first support structure including the pivot pivotally supports the barrier; and
a key to unlock the locking device.

11. Ladder assembly including access control apparatus, the assembly comprising:
a ladder;
a first member including a first support structure and a first attachment mechanism which secures the first support structure to a first side of the ladder;
a second member including a second support structure and a second attachment mechanism which secures the second support structure to a second side of the ladder spaced apart from the first side of the ladder;
a planar barrier supported by the first support structure to move within a plane of the barrier between an access position to allow access to the ladder and a blocking position to prevent access to the ladder; and
a locking device which fastens the planar barrier to the second support structure in a locked condition of the device in the blocking position of the barrier to prevent unauthorized access to the ladder.

12. The assembly as claimed in claim 11, wherein the barrier moves by rotating about a pivot axis perpendicular to the plane of the barrier.

13. The assembly as claimed in claim 12, wherein the first support structure includes a pivot to allow the barrier to pivot about the pivot axis.

14. The assembly as claimed in claim 11, wherein the barrier includes an aperture formed therein and wherein the locking device is supported on the second support structure and includes a bolt having extended and retracted positions, the bolt being in its extended position in the aperture in the locked condition to fasten the barrier to the second support structure in the blocking position.

15. The assembly as claimed in claim 14, wherein the aperture extends completely through the barrier and wherein the second member includes a shield which covers a distal end of the bolt in the extended position of the bolt.

16. The assembly as claimed in claim 11, wherein the locking device is supported on the second support structure.

17. The assembly as claimed in claim 16, wherein the locking device is supported on the second support structure either above or below the barrier when the barrier is in its blocking position to prevent unauthorized users from climbing on the ladder and to allow authorized users to unlock the locking device.

18. The assembly as claimed in claim 11, wherein the locking device is a keyed or combination locking device.
